(19) United States
(12) Patent Application Publication
(10) Pub. No.: US 2015/0298661 A1
(43) Pub. Date: Oct. 22, 2015

(54) AN ELECTRONIC VEHICLE BATTERY REPLACEMENT SYSTEM

(71) Applicant: Wujie ZHANG, Taizhou (CN)

(72) Inventor: Wujie ZHANG, Taizhou (CN)

(21) Appl. No.: 14/403,521

(22) PCT Filed: Apr. 25, 2013
(86) PCT No.: PCT/CN2013/000472

§ 371 Date: Nov. 24, 2014

(30) Foreign Application Priority Data
Jun. 24, 2012 (CN) 201210228784.4

(51) Int. Cl. B60S 5/06; B60K 1/04; B65G 15/22

(52) U.S. Cl. CPC B60S 5/06; B65G 15/22; B60K 1/04; B60K 2001/0438; B60K 2001/0455

(57) ABSTRACT

The present disclosure discloses an electric vehicle battery replacement system comprising a vehicle-mounted battery driving device and a battery conveying device outside of the vehicle. The vehicle-mounted battery driving device comprises a drive roller configured to carry a battery and connected with a drive motor. The battery conveying device outside of the vehicle comprises three conveying belts each connected to one of three conveying motors, respectively. The drive roller, a first conveying belt, and a second conveying belt are arranged successively on a same horizontal plane along a direction of conveying. The third conveying belt is located above the second conveying belt and connected with the first conveying belt via a sliding plate. One end of the sliding plate connects flexibly to a front end of the third conveying belt, and the other end of the sliding plate is placed on the first conveying belt. The battery replacement system provided in the present disclosure solves such problems as long charging time and low efficiency in public charging stations by using the current charging method of existing electric vehicles, and meets the growing demand of the increasing number of electric vehicles.

### TECHNICAL FIELD

The present invention belongs to the field of electric vehicle devices, and particularly relates to an electronic vehicle battery replacement system.

### BACKGROUND

As the non-renewable energy resources such as petroleum and natural gas are being exhausted and the technology of utilizing such clean energies as solar energy and wind energy is far from mature, the human beings are facing great challenges for living and development. Every day, hundreds of millions of automobiles in the world are consuming a substantial proportion of petroleum and natural gas. Currently, there is no effective alternative energy for automobiles. If the electric power carried by batteries can be used as a substitute for petroleum and natural gas to drive automobiles, not only can the service duration of petroleum be greatly prolonged, but also emission from automobiles can be reduced. Though such energy resources as coal, petroleum and natural gas are consumed and harmful gases to the environment are produced during electricity generation by power plants, the harm caused by power plants is far less compared with the oil consumption and emission by so many automobiles, and high efficiency in energy consumption is achieved by using electricity to drive automobiles. Therefore, use of electric vehicles to substitute automobiles consuming gasoline and natural gas will be a main trend within a certain period in the future. However, the use and promotion of electric vehicles are largely restricted due to such factors as the limited battery capacity and long charging time. Although some manufacturers have introduced fast charging technology that may charge about 80% of the electric capacity of a battery within twenty to thirty minutes, to avoid traffic congestion caused by too many vehicles waiting for charging, there is a high demand for charging stations, for more open space for charging stations, and for the construction of a large number of charging points.

### SUMMARY OF THE DISCLOSURE

To solve the problems of long charging time and low efficiency in public charging stations using the current charging method that are difficult to meet the growing demand of the increasing number of electric vehicles, the present disclosure provides an electric vehicle battery replacement system.

According to some embodiments, an electronic vehicle battery replacement system comprises a vehicle-mounted battery driving device and a battery conveying device outside of the vehicle. The vehicle-mounted battery driving device comprises a drive roller configured to carry a battery and connected with a drive motor. The battery conveying device outside of the vehicle comprises three conveying belts each connected with one of three conveying motors, respectively. The drive roller, a first conveying belt, and a second conveying belt are arranged successively on a same horizontal plane along the direction of conveying. The third conveying belt is located above the second conveying belt and connected with the first conveying belt via a sliding plate. One end of the sliding plate connects flexibly to a front end of the third conveying belt. The other end of the sliding plate is placed on the first conveying belt. Realization of battery replacement through the vehicle-mounted battery driving device and the battery conveying device outside of the vehicle has a number of advantages. For example, the drive motor can drive the drive roller carrying a battery, thus drawing the used battery outside the body of the vehicle and into the battery conveying device outside of the vehicle. The used battery will be recycled by moving along the first conveying belt, the sliding plate, and the third conveying belt. Then the conveying motors connected with the first conveying belt and the second conveying belt, respectively, and the drive motor connected with the drive roller all rotate reversely, thereby allowing a new battery to move along the second conveying belt, through below the jacked sliding plate, and then along the first conveying belt to be carried into the vehicle-mounted battery driving device.

According to some embodiments, in the above-described electronic vehicle battery replacement system, the vehicle-mounted battery driving device is located below a floor between the front and the rear wheels of the electric vehicle, and a corresponding battery access is set on a side of the body of the vehicle. This makes it easier to protect and to replace the battery.

According to some embodiments, in the above-described electric vehicle battery replacement system, the body of the vehicle comprises a fixed drive motor control panel comprising one or more switches connected to the drive motor for forward rotation, reverse rotation, and stopping of the drive motor. Rotation of the drive roller and the carry-in and carry-out of batteries can be controlled via the one or more forward rotation, reverse rotation, and stopping switches on the control panel.

According to some embodiments, in the above-described electric vehicle battery replacement system, the body of the vehicle comprises a charging port connected with the drive motor for insertion of and connection with a transmission gun. According to some embodiments, the head of the transmission gun comprises a plug structure matching a socket within the charging port and outside the plug is a retractable cover. Provision of the external transmission gun reduces self-carried power source of the electric vehicle and thus reduces the weight of the electric vehicle. The retractable cover outside the plug can protect the plug and prevent electric shock of an operator.

According to some embodiments, in the above-described electric vehicle battery replacement system, one end of the sliding plate is hinged on the front end of the third conveying belt, and the other end of the sliding plate comprises a roller which is placed on the first conveying belt. The function of the roller is to prevent friction between the sliding plate and the first conveying belt.

According to some embodiments, in the above-mentioned electric vehicle battery replacement system, the vehicle-mounted battery driving device comprises a fixed limit switch connected with the drive motor. When a battery is carried to a predetermined position within the body of the vehicle, the limit switch is pushed, thereby cutting off power to the drive motor so that the drive motor stops working. The function of the limit switch is to prevent the battery from being drawn by the drive roller beyond the predetermined position and thus causing damage to other devices.

According to some embodiments, in the above-mentioned electric vehicle battery replacement system, each of the three conveying motors is connected with a central control computer. A gravity sensor is also fixed below each of the first conveying belt, the second conveying belt, and the third conveying belt, and each of the three gravity sensors is connected to the central control computer. The sensors installed below the conveying belts can transmit signals they obtain to the central control computer, thereby allowing the central control computer to successively initiate the forward rotation of the conveying motors connected with the first conveying belt and the third conveying belt. Then the central control computer can initiate the reverse rotation of the conveying motors connected with the first conveying belt and the second conveying belt, thereby allowing a new battery to be carried in along the second conveying belt, through below the jacked sliding plate, and then along the first conveying belt.

The present disclosure provides a new battery replacement system for electric vehicles, which can realize fast and efficient replacement of electric vehicles' batteries, and eliminate the trouble brought by long charging time of the batteries.

### BRIEF DESCRIPTION OF THE DRAWINGS

To clarify the technical features disclosed in the embodiments of the disclosure, a brief description of the figures in support of the disclosed embodiments is provided below. It should be understood that the figures only illustrate a number of embodiments of the disclosure. Additional figures can be derived from these figures by a person skilled in the art.

FIG. 1 is a schematic diagram illustrating an exemplary structure of an electric vehicle according to some embodiments of the disclosure.

FIG. 2 is a schematic diagram illustrating a vehicle-mounted battery driving device according to some embodiments of the disclosure.

FIG. 3 is a schematic diagram illustrating a battery conveying device outside of a vehicle according to some embodiments of the disclosure.

FIG. 4 is a schematic diagram illustrating an exemplary structure of a transmission gun plug according to some embodiments of the disclosure.

FIG. 5 is a schematic diagram illustrating the compression of a transmission gun plug cover according to some embodiments of the disclosure.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the broadest scope consistent with the claims.

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

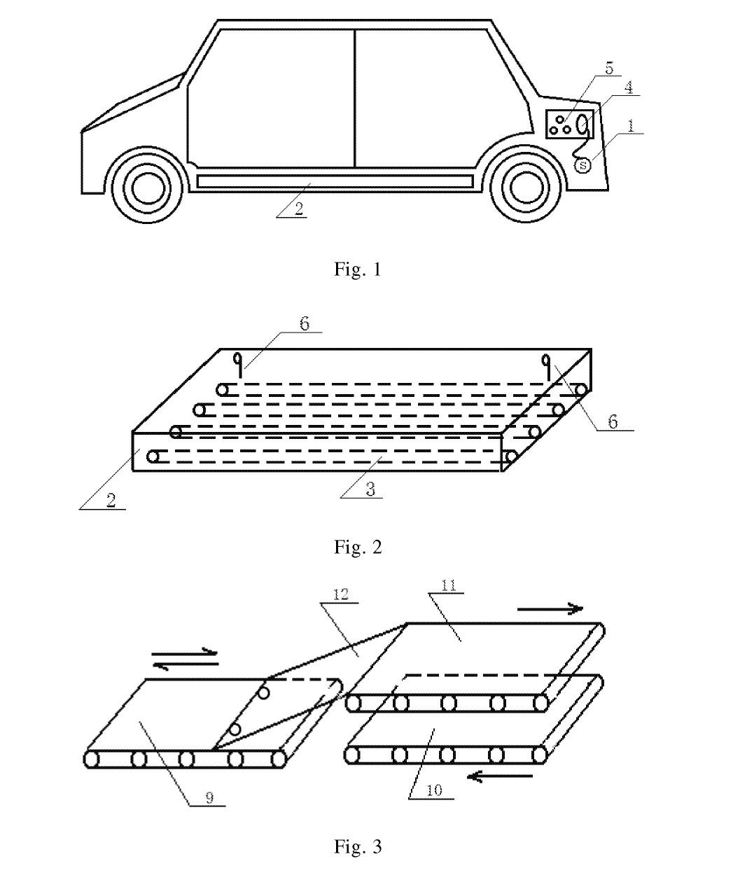

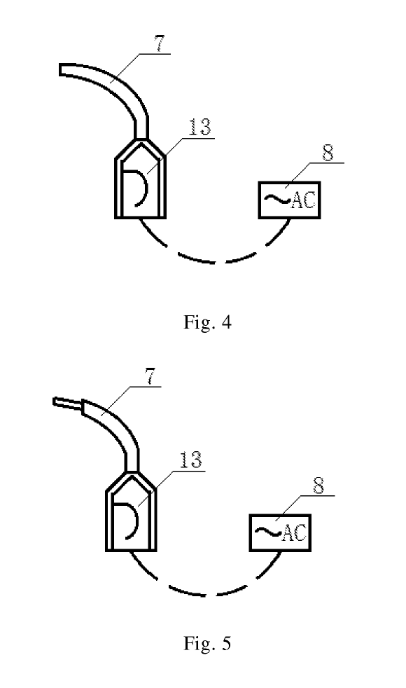

FIG. 1 is a schematic diagram illustrating an exemplary structure of an electric vehicle according to some embodiments of the disclosure. According to these embodiments, an electric vehicle battery replacement system comprises a vehicle-mounted battery driving device and a battery conveying device outside of the vehicle. The vehicle-mounted battery driving device comprises a drive roller 3 configured to carry a battery and connected with a drive motor 1. FIG. 2 is a schematic diagram illustrating a vehicle-mounted battery driving device according to some embodiments of the disclosure. The battery conveying device outside of the vehicle comprises three conveying belts each connected with one of three conveying motors, respectively. The drive roller 3, a first conveying belt 9, and a second conveying belt 10 are arranged successively on a same horizontal plane along the direction of conveying. The third conveying belt 11 is located above the second conveying belt 10 and connected with the first conveying belt 9 via a sliding plate 12. One end of the sliding plate 12 connects flexibly to a front end of the third conveying belt 11. The other end of the sliding plate 12 is placed on the first conveying belt 9. FIG. 3 is a schematic diagram illustrating a battery conveying device outside of a vehicle according to some embodiments of the disclosure. The vehicle-mounted battery driving device is located below a floor between the front and the rear wheels of an electric vehicle, and a corresponding battery access 2 is set on a side of the body of the vehicle. The body of the vehicle comprises a fixed drive motor control panel 5 comprising one or more switches connected to the drive motor 1 for forward rotation, reverse rotation, and stopping of the drive motor 1. The body of the vehicle comprises a charging port 4 connected with the drive motor 1 for insertion of and connection with a transmission gun 7. The head of the transmission gun 7 comprises a plug structure matching a socket within the charging port. FIG. 4 is a schematic diagram illustrating an exemplary structure of a transmission gun plug according to some embodiments of the disclosure. Outside the plug is a retractable cover. One end of the sliding plate 12 is hinged on the front end of the third conveying belt 11, and the other end of the sliding plate 12 comprises a roller which is placed on the first conveying belt 9. The vehicle-mounted battery driving device comprises a fixed limit switch 6 connected with the drive motor 1. Each of the three conveying motors is connected with a central control computer. A gravity sensor is also fixed below each of the first conveying belt 9, the second conveying belt 10, and the third conveying belt 11, and each of the three gravity sensors is connected to the central control computer.

When the electric vehicle has come to a full stop and become stable, the electric vehicle can be switched off. A hydraulic clamp controlled by a computer in a central control room can be used to hold the front wheels of the electric vehicle for manipulating movement of the vehicle. Using such positioning technology as infrared focusing for positioning, the battery access 2 of the electric vehicle can be precisely aligned with the access of a battery conveying device outside of the vehicle. A transmission gun 7 can be removed and inserted into the charging port 4 of the electric vehicle. At this time, the retractable cover at the transmission gun head can be compressed inward under pressure. FIG. 5 is a schematic diagram illustrating a compressed transmission gun plug cover according to some embodiments of the disclosure. The exposed plug can then get full contact with a socket within the charging port 4. An option switch on the control panel on the body of the vehicle can be placed at the “Forward Rotation” position. A switch 13 on the transmission gun 7 can be pressed to connect the drive motor 1 within the electric vehicle to an external power source 8, thereby driving the drive roller 3 below the battery to draw a used battery out of the body of the vehicle and into the battery conveying device outside of the vehicle. The sensors installed below the conveying belts 9, 10, and 11 will transmit signals obtained to a central control computer, which will successively initiate forward rotation of the conveying motors connected with the first conveying belt 9 and the third conveying belt 11. The used battery will be carried out by the first conveying belt 9, the sliding plate 12 and then the third conveying belt 11 and recycled. Subsequently, the central control computer can initiate reverse rotation of the conveying motors connected with the first conveying belt 9 and the second conveying belt 10, and a new battery will move along the second conveying belt 10, through below the jacked sliding plate 12, and then along the first conveying belt 9 and be carried out of the battery conveying device outside of the vehicle. The option switch on the control panel can then be placed at the “Reverse Rotation” position. Then the switch 13 on the transmission gun 7 can be pressed to draw the new battery into the body of the vehicle. While the new battery arrives at a predetermined position within the body of the vehicle, the limit switch can cut off power to the drive motor 1 so that the drive motor 1 stops working. Finally, the transmission gun 7 can be removed, the option switch on the control panel can be placed at the “Stop” position, and the cover of the charging port can be closed. This completes the battery replacement for the electric vehicle.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. An electric vehicle battery replacement system comprising a vehicle-mounted battery driving device and a battery conveying device outside of the vehicle, wherein the vehicle-mounted battery driving device comprises a drive roller 3 configured to carry a battery and connected with a drive motor 1, and the battery conveying device outside of the vehicle comprises three conveying belts each connected to one of three conveying motors, respectively, wherein
the drive roller 3, a first conveying belt 9, and a second conveying belt 10 are arranged successively on a same horizontal plane along a direction of conveying,
a third conveying belt 11 is located above the second conveying belt 10 and connected with the first conveying belt 9 via a sliding plate 12,
one end of the sliding plate 12 connects flexibly to a front end of the third conveying belt 11, and
the other end of the sliding plate 12 is placed on the first conveying belt 9.

2. The electric vehicle battery replacement system of claim 1, wherein the vehicle-mounted battery driving device is located below a floor between the front and the rear wheels of the vehicle, and a corresponding battery access 2 is set on a side of the body of the vehicle.

3. The electric vehicle battery replacement system of claim 1, wherein the body of the vehicle comprises a fixed drive motor control panel 5 comprising one or more switches connected to the drive motor 1 for forward rotation, reverse rotation, and stopping of the drive motor 1.

4. The electric vehicle battery replacement system of claim 1, wherein the body of the vehicle comprises a charging port 4 connected with the drive motor 1 for insertion of and connection with a transmission gun 7, the head of the transmission gun 7 comprises a plug structure matching a socket within the charging port 4, and outside the plug is a retractable cover.

5. The electric vehicle battery replacement system of claim 1, wherein one end of the sliding plate 12 is hinged on the front end of the third conveying belt 11, and the other end of the sliding plate 12 comprises a roller which is placed on the first conveying belt 9.

6. The electric vehicle battery replacement system of claim 1, wherein the vehicle-mounted battery driving device comprises a fixed limit switch 6 connected with the drive motor 1.

7. The electric vehicle battery replacement system of claim 1, wherein each of the three conveying motors is connected with a central control computer, a gravity sensor is fixed below each of the first conveying belt 9, the second conveying belt 10, and the third conveying belt 11, and each of the three gravity sensors is connected to the central control computer.
